(19) United States
(12) Patent Application Publication
(10) Pub. No.: US 2004/0170433 A1
(43) Pub. Date: Sep. 2, 2004

(54) Survival dwdm system

(76) Inventors: Giovanni Caprino, Genova (IT); Roberto Magri, Parma (IT); Andrea Rivolta, Genova (IT)

Correspondence Address: KIRSCHSTEIN, OTTINGER, ISRAEL, & SCHIFFMILLER, P.C., 489 FIFTH AVENUE, NEW YORK, NY, 10017

(21) Appl. No.: 10/473,273

(22) PCT Filed: Mar. 26, 2002
(86) PCT No.: PCT/IB02/02032

(51) Int. Cl. H04J 14/02

(52) U.S. Cl. 398/83

(57) ABSTRACT

A traffic survival method in optical fiber telecommunication systems and in particular DWDM and having amplification sites (10) with ADD/DROP of channels and arranged between fiber spans is described and claimed. In accordance with the method the ASE noise produced in amplifiers (13) in the site is amplified in power to compensate at output the power of channels (n) lost by breakage of the site inpul span. An amplification device with ADD/DROP and a telecommunication system with it is also described and claimed.

The present invention relates to an innovative method for allowing added traffic survival in a span in optical fiber telecommunication systems in case of link breakage in the preceding span. The present invention also relates to a device in accordance with said method and a telecommunication system provided by said method or said device.

In a WDM system with ADD/DROP optical capability a set of n channels travels over the nth span which ends in an amplification site. In the site the signals are amplified by a preamplifier (PA) and after attenuation caused by the presence of other components such as DCF fibers or fixed or variable attenuators et cetera it reaches an ADD/DROP filter. Here a subset made up of ‘d’ channels is taken out (DROP) and a new subset made up of ‘a’ channels is added (ADD) in the system. At the ADD/DROP output there are thus n−d+a channels which are amplified by a power amplifier (booster) and moved into the following span n+lth.

In such a system the added traffic in an amplification site must survive in case of link breakage, for example fiber breakage in the previous span.

If a break occurs, for example fiber breakage in the nth span, the n channels and consequently the removed ‘d’ channels are lost but the new added channels must continue to work without being affected by the consequences of the breakage. This last condition is satisfied only if the power amplifier gain remains unchanged so that the added channels do not have to undergo power changes.

A prior art solution to the problem is to consider that after the fiber breakage the system will have a different configuration, i.e. a different number of channels, and thus all the cards in the system must be reset in accordance with the new configuration.

This requires turning off the amplifier PA and comnunication of the new settings to all the cards involved in the transmission of the surviving channels. These cards can be different cards of a single sub-rack but can also be cards in other sub-racks or even in other system site. The procedure therefore takes some time in order to inform all the system cards about the new configuration and allow the cards the time necessary for changing their settings.

During this time the system is in an uncontrolled transition situation and the added channels which must continue to work can be influenced negatively thereby with traffic loss.

If the time necessary for completion of the procedure is longer than the traffic recovery time required by the client this prior art solution is not feasible.

Other prior art solutions involve an additional channel used to compensate the power of the lost channels but this solution requires costly software and hardware development from the viewpoint of development time and additional cost. The general purpose of the present invention is to remedy the above mentioned shortcomings by making available a solution based on a different approach in which the amplifier PA is not turned off and on the contrary is used to compensate the power of the lost channels with no requirement for communication between the cards and system resetting times. Another advantage of the proposed solution is that it requires no particular additional hardware and software development.

In view of this purpose it was sought to provide in accordance with the present invention a traffic survival method in optical fiber telecommunication systems and in particular DWDM having amplification sites with ADD/DROP of channels arranged between fiber spans and in which the ASE noise produced in amplifiers in the site is amplified in power to compensate at output the power of channels lost due to breakage of the site input span.

Again in accordance with the present invention it was sought to provide an optical ADD/DROP amplification device designed to be arranged in an amplification site between optical fiber spans in an optical fiber telecommunication system and comprising along the signal path between the input and the output an input amplifier, an ADD/DROP device for channels and an output amplifier characterized in that the input amplifier has feedback which keeps the amplifier output power virtually constant at P_{outPA} regardless of the input signal to amplify the power of the input channels to the site up to the power P_{outPA} and to amplify the power of the ASE noise in the amplifier up to a power Pₐₛₑ virtually equal to the power Pₒᵤₜ in case of lack of input signal in such a manner as to compensate the power of channels lost due to breakage of the site input span with the ASE noise.

Lastly, it was sought to provide an optical fiber telecommunication system comprising a plurality of amplification sites with ADD/DROP of channels and connected together by optical fiber spans and in which at least one site comprises a device and /or applies the above method.

To clarify the explanation of the innovative principles of the present invention and its advantages compared with the prior art there is described below with the aid of the annexed drawings a possible embodiment thereof by way of non-limiting example applying said principles. In the drawings:

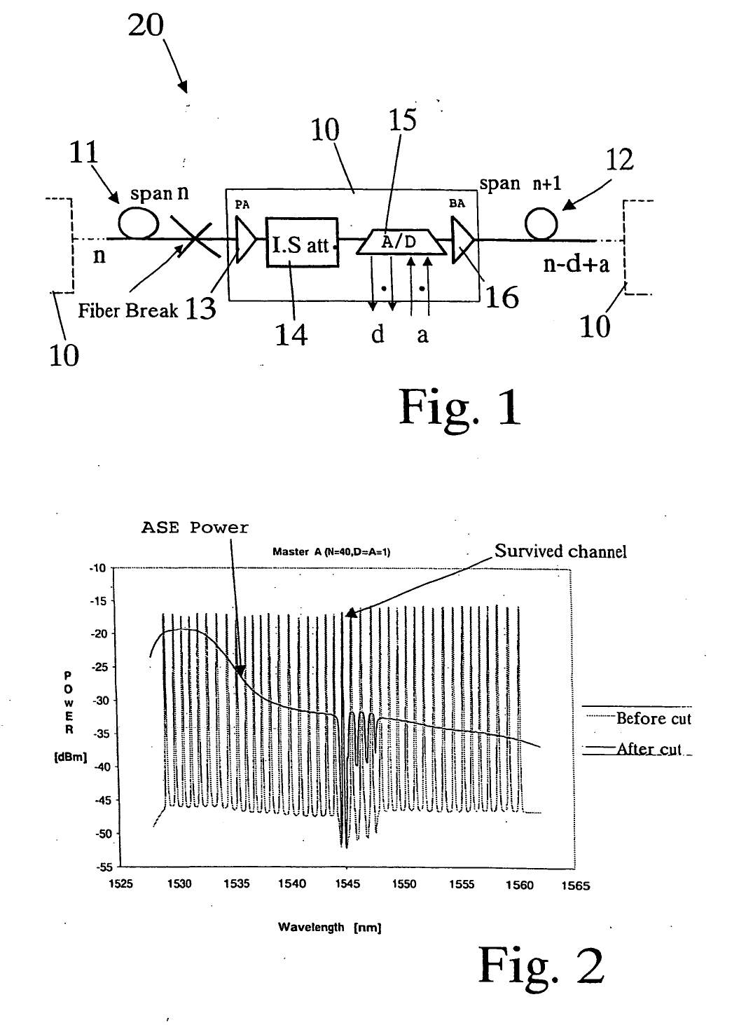

FIG. 1 shows a block diagram of an amplification site with an optical fiber link entering span and an optical fiber link emerging span, and

FIG. 2 shows an explanatory graph of the operating principles of the present invention.

With reference to the figures FIG. 1 shows diagrammatically an optical fiber telecommunication system with one of n amplification sites with ADD/DROP designated as a whole by reference number 20. A preceding optical fiber span 11 arrives at each site 10 and a following optical fiber span 12 emerges from each site.

The site 10 comprises an input preamplifier 13 (PA) which receives the signal from the preceding span and sends it amplified to signal treatment members 14 (DCF fibers, fixed or variable attenuators et cetera) of the prior art and therefore not further discussed herein. The signal then reaches an ADD/DROP device or filter 15 where a certain number ‘d’, of channels is withdrawn and a new subset made up of a certain number ‘a’of channels is added to the system. At the ADD/DROP device output there are thus n−d+a channels which are amplified by a power amplifier or booster 16 (BA) and moved into the following span 12.

Like all the active components, the optical amplifiers are characterized by a certain degree of noise. The main source of noise is a spontaneous emission of the active span of the optical amplifier which produces a random disturbance with null mean. This noise is generally termed Amplified Spontaneous Emission (ASE) noise.

In the production of optical amplifiers it is naturally sought to keep ASE noise at negligible amounts in relation to the signal. In normal amplifier operation i.e. with input signal, the ASE noise therefore has power much lower than the signal power. On the other hand when there is no input in the amplifier the latter can emit only ASE noise at output. Usually this ASE noise is not of interest and in the prior art it is immediately eliminated by turning off the amplifier when it receives no input signal.

In accordance with the innovative method of the present invention when the amplifier receives no input, for example because of fiber breakage of the span entering the site, instead of suppressing the ASE noise an ASE noise with equal power is substituted for the lacking signal power. The site optical amplifiers are allowed to work with constant output power settable by means of known electronic control loops. The laser pumps are also controlled in a known manner in order to hold constant the output power without regard for the input power.

The output amplifier 16 (BA) is considered an ideal amplifier with flat gain. If we define:

Pₐ=power of added channels input to BA,

hd ch=power of N-D channels input to BA before fiber breakage,

Pₐₛₑ=power of PA ASE noise at BA input after fiber breakage,

P_{outBA}=BA output power,

P_{outPA}=PA output power, and

G₁, G₂=BA gain before and after fiber breakage,

Since it is required that the BA output power must remain constant and equal to PoutBA, we will have:

G1(Pch+Pa)=PoutBA (before fiber breakage) (1)

G2(Pase+Pa)=PoutBA (after fiber breakage) (2)

To ensure survival of the traffic of the added channels it is necessary that their power not change after fiber breakage. A change in the power level in the added channel would affect its performance because of the limited dynamic range of the system or the non-linear effects. To secure this condition it is necessary to have [see equations (1) and (2)]:

G1=G2→Pₐₛₑ=P_{ch} (3)

Equation (3) states that the power of the ASE noise must be equal to the power of the lost channels. Assuming that the N channels are equalized in power we can write:

P_{ch}/P_{outPA}=(N-D)/N

and with equation (3) it becomes:

Pₐₛₑ/P_{outPA}=(N-D)/N (4)

This relationship would require a different setting between the power of the amplifier PA before and after the fiber breakage to control P_{outPA} e Pₐₛₑ separately. This is not feasible because it would require the ability of the PA to detect a break in the fiber in the link and change its own settings, thus falling back into the disadvantages of the prior art solutions above mentioned.

For this reason the following rule is established.

Pₐₛₑ=P_{outPA} (5)

Requiring as mentioned above that the amplifier be controlled so as to have constant output power without concern for the input power, equation (5) is automatically verified because of the amplifier control loop. In other words, when there is no input signal the amplifier increases its power gain to amplify the internal noise until it takes its own output power to the value which it was predetermined that it should keep.

It was found that observation of equation (5) instead of (4) provides satisfactory performance when D<<N and can give only relatively small disadvantages when D≅N. These last consist of a change in the power of the surviving channels after fiber breakage and must be taken into account when the flexibility of the link is appraised. But during normal operation of the system, i.e. with no broken fibers, the solution described adds no disadvantage since the system operates indistinguishably from the conventional system.

The output booster amplifier has a feedback for holding output power virtually constant within a reasonable interval of input power.

FIG. 2 is a graph which clarifies operation of the system in accordance with the present invention by showing practical measurements on a sample system in which forty channels travel in the system and reach an ADD/DROP site. In the site a channel is taken out and one is added. The spectrum shown in FIG. 2 is measured after the BA output both before and after fiber breakage caused by disconnecting the PA input.

From the spectrum the profile of the ASE noise which replaces the 39 channels lost after fiber breakage can be seen. It can also be seen that the surviving channel has suffered a negligible power change of <1 dB which shows the effectiveness of the solution described and claimed here. It is now clear that the predetermined purposes have been achieved by making available a method, device and optical fiber telecommunication system which enable excellent traffic survival in spans following a broken span.

Naturally in a not ideal actual system the actual behavior of the amplifiers can add some small disadvantages, for example because of the strong amplification necessary for raising the ASE noise power up to a power comparable to that of the lost channels. The impact of this on the system depends on the strength of the system, amplifier design, link configuration, architecture, channel setting et cetera. An appropriate design can however minimize any disadvantages as is readily imaginable to those skilled in the art. In addition, some easy practical measurements of the actual system are sufficient to see any disadvantages introduced by application of the solution in accordance with the present invention in the worst cases and then consider these added disadvantages when the estimated cost of the system is calculated.

The advantages of the solution described are in any case much greater than any limited disadvantages. These limited disadvantages can be minimized or eliminated by easy practical design choices in accordance with the normal knowledge of those skilled in the art.

The solution described allows survival of added channels in a DWDM system with ADD/DROP in a variety of configurations which can be produced practically without additional hardware and software development.

This makes the ADD/DROP feature available in a short time with limited costs for a large number of system configurations.

Naturally the above description of an embodiment applying the innovative principles of the present invention is given by way of non-limiting example of said principles within the scope of the exclusive right claimed here.

For example the exact structure of the amplification site can be different from that shown diagrammatically and even comprise additional members for particular handling of the input and output signals on the span links and the ADD/DROP links.

1. Traffic survival method in optical fiber telecommunication systems and in particular DWDM and having amplification sites with ADD/DROP of channels and arranged between fiber spans and in which the ASE noise produced in amplifiers in the site is amplified in power to compensate at output the power of channels lost by breakage of the site input span.

2. Method in accordance with claim 1 in which the noise power amplification is obtained by requiring that at least one amplifier of the site arranged upstream of the ADD/DROP of the channels have feedback to keep its own output power virtually constant at a predetermined P_{outPA} value independently of the input signal in such a manner as to amplify the power of the channels input to the site up to power P_{outPA} and amplify the power of its own internal ASE noise up to a power Pₐₛₑ virtually equal to the power P_{outPA} if there is no input signal.

3. Method in accordance with claim 1 in which an output booster amplifier of the site is controlled to keep its own output power virtually constant within a predetermined input power range.

4. Optical ADD/DROP amplification device designed to be arranged in an amplification site between optical fiber spans in an optical fiber telecommunication system and comprising along the signal path between the input and the output an input amplifier a channel ADD/DROP device and an output amplifier characterized in that the input amplifier has feedback which keeps the amplifier output power virtually constant at P_{outPA} independently of the input signal to amplify the power of the channels input to the site up to the power P_{outPA} and to amplify the power of the ASE noise in the amplifier up to a power Pₐₛₑ virtually equal to the power Pout in case of lack of input signal in such a manner as to compensate with the output ASE noise the power of the channels lost due to breakage of the site input span.

5. Optical fiber telecommunication system comprising a plurality of amplification sites with ADD/DROP of channels and connected together by optical fiber spans and in which at least one site comprises a device and/or applies the method in accordance with any of the above claims.
